(19) United States
(12) Patent Application Publication
(10) Pub. No.: US 2021/0197287 A1
(43) Pub. Date: Jul. 1, 2021

(54) INTEGRATED INSPECTION SYSTEM FOR 3D PRINTING PROCESS BASED ON THERMAL IMAGE AND LASER ULTRASOUND WAVE AND 3D PRINTING SYSTEM HAVING THE SAME

(71) Applicant: Korea Advanced Institute of Science and Technology, Daejeon (KR)

(72) Inventors: Hoon SOHN, Daejeon (KR); Ikgeun JEON, Daejeon (KR); Peipei LIU, Daejeon (KR)

(73) Assignee: Korea Advanced Institute of Science and Technology, Daejeon (KR)

(21) Appl. No.: 17/130,641

(22) Filed: Dec. 22, 2020

(30) Foreign Application Priority Data
Dec. 31, 2019 (KR) 10-2019-0179186

(51) Int. Cl. B22F 12/90; G02B 27/10; B22F 10/28; B22F 10/22; B22F 10/30; B33Y 30/00; B33Y 50/02

(52) U.S. Cl. CPC B22F 12/90; G02B 27/1006; B22F 10/28; B33Y 50/02; B22F 10/30; B33Y 30/00; B22F 10/22

(57) ABSTRACT

Disclosed are an integrated inspection system for a 3D printing process using a thermal image and a laser ultrasound wave and a 3D printing system having the inspection system. The inspection system includes a thermal imaging camera for creating a thermal image of a molten pool formed in a printing object when a base material supplied to the printing object is melted by a laser beam irradiated from a 3D printing laser source, a laser ultrasonic device for receiving a laser ultrasonic wave included in the laser beam reflected from the printing object, and a control unit for estimating a physical property of the printing object and detecting a defect of the printing object based on the thermal image created by the thermal imaging camera and the laser ultrasound wave received by the laser ultrasonic device. The thermal imaging camera and the laser ultrasonic device are disposed coaxially with the 3D printing laser source.

### CROSS-REFERENCE TO RELATED APPLICATION

This U.S. non-provisional application claims priority under 35 USC § 119 from Korean Patent Application No. 10-2019-0179186, filed on Dec. 31, 2019 in the Korean Intellectual Property Office (KIPO), the disclosure of which is hereby incorporated by reference in its entirety.

### BACKGROUND

### 1. Technical Field

The present invention relates to a three-dimensional (3D) printing technology, and more specifically, an integrated inspection system that can estimate a physical property and detect a defect of a 3D printing object in an online and non-destructive manner based on data fusion of thermal images and laser ultrasound waves in a 3D printing process, and a 3D printing system having the inspection system.

### 2. Description of the Related Art

The 3D printing is known as a manufacturing technology for producing a 3D object. For the 3D printing of the 3D object, it is processed in a way that stacks layer by layer based on the 3D model data processing information. The 3D printing technology has advantages that facilitate realization of a complex shape, a shape formed inside a product, etc. Due to these advantages, the 3D printing technology is in the spotlight as a high value-added technology that makes it easy to manufacture various products such as various industrial parts and medical materials.

The 3D printing process can be performed by dividing the shape of a 3D product into a number of 2D cross sections having a uniform or variable thickness, and forming the 2D cross sections to be stacked one by one. There are several known 3D printing methods such as a material extrusion method, a material jetting method, a binder jetting method, a sheet lamination method, a vat photo-polymerization method, a powder bed fusion method, a directed energy deposition (DED) method, etc. Among them, the DED method is a method of applying laser energy to metal powder or wire material to be melted and fused, and is widely used because of its advantages that it can use inexpensive commercial materials compared to other methods, form a lamination on existing 3D shapes, and have superior mechanical properties compared to other methods.

In the 3D printing according to the DED method, a molten pool is formed when a laser beam irradiated from a laser source is irradiated to the substrate, and metal powder is supplied onto the molten pool to form a lamination.

In general, the quality inspection in the 3D printing process is performed by a non-destructive or destructive test on some selected sample products among the completed products. In 3D printing, for example, it is one of the most important whether the physical property such as stiffness of the printing product reaches the target value or not. However, there is no technology capable of properly inspecting the physical property during the 3D printing process. Accordingly, there is a demand for the development of an online technology or system for capable of inspecting the physical property such as stiffness and strength, and dimensions such as thickness of 3D printing object during the 3D printing process.

In addition, there are some known techniques that can measure simply the temperature and vision image of the 3D printing object in the 3D printing system. However, there are no techniques or systems that can inspect defects of the 3D printing object such as gases and elongated pores, cracks and delaminations inside the printed 3D printing object in real-time during the 3D printing process. Therefore, there is a need to develop a nondestructive evaluation technology capable of detecting the defects during the 3D printing process.

### SUMMARY

In order to solve the problems of the prior art as described above, some embodiments of the present invention are to provide an integrated inspection system that can inspect the physical property and defect of the 3D printing object in real time during the 3D printing process based on data fusion of thermal images and laser ultrasound waves.

Some embodiments of the present invention are to provide a 3D printing system having the inspection system.

In one aspect, some embodiments of the present disclosure provide an integrated inspection system for a 3D printing process based on a thermal image and a laser ultrasound wave. The integrated inspection system includes a thermal imaging camera, a laser ultrasonic device, and a control unit. The thermal imaging camera is configured to create a thermal image of a molten pool formed in a printing object when a base material supplied to the printing object is melted by a laser beam irradiated from a 3D printing laser source. The laser ultrasonic device is configured to receive a laser ultrasonic wave included in a laser beam reflected from the printing object after being radiated onto the printing object. The control unit is configured to estimate a physical property of the printing object and detect a defect of the printing object based on the thermal image created by the thermal imaging camera and the laser ultrasound wave received by the laser ultrasonic device. The thermal imaging camera and the laser ultrasonic device are disposed coaxially with the 3D printing laser source.

In an embodiment, the control unit may detect presence of a defect in the printing object according to an additional reflected wave of the laser ultrasound wave and a change in a thermal energy distribution of the thermal image.

In an embodiment, the control unit may estimate a stiffness of the printing object according to an arrival time and a wave speed of the laser ultrasound wave and a thermal energy transfer speed of the thermal image.

In an embodiment, the control unit may calculate a response of the laser ultrasound wave using a pulse-echo technique or a pitch-catch technique.

In an embodiment, the integrated inspection system may further include a first beam splitter disposed on a path of the laser beam irradiated from the 3D printing laser source and configured to separate a part of the laser beam reflected from the printing object unit toward the thermal imaging camera; and a second beam splitter disposed on a path of the laser beam irradiated from the 3D printing laser source and configured to separate a part of the laser beam reflected from the printing object toward the laser ultrasonic device.

In an embodiment, the integrated inspection system may further include a first filter unit disposed between the first beam splitter and the thermal imaging camera and configured to allow a light beam of an operational wavelength band of the thermal imaging camera to pass; and a second filter unit disposed between the second beam splitter and the laser ultrasonic device and configured to allow a signal of an operational wavelength band of the laser ultrasonic device to pass.

In an embodiment, the thermal imaging camera and the laser ultrasonic device may have an operational wavelength band different from that of the 3D printing laser source.

In an embodiment, the thermal imaging camera may have an operational wavelength band of 2˜5 μm.

In an embodiment, the laser ultrasonic device may have an operational wavelength band of 515 nm or less.

In an embodiment, the 3D printing laser source may have an operational wavelength band of 1.07 μm or less.

In an embodiment, the laser ultrasonic device may be a femtosecond laser device.

In an embodiment, the integrated inspection system may further include a vision camera configured to create an image of the printing object; a third beam splitter disposed on a path of the laser beam irradiated from the 3D printing laser source and configured to separate a part of the laser beam reflected from the printing object toward the vision camera; and a third filter unit disposed between the third beam splitter and the vision camera and configured to allow a light beam of an operational wavelength band of the vision camera to pass.

In another aspect, some embodiments of the present disclosure provide a 3D printing system. The 3D printing system includes a 3D printing laser source, a base material supply source, a thermal imaging camera, a laser ultrasonic device, and a control unit. The 3D printing laser source is configured to irradiate a laser beam to melt a base material supplied to a printing object and to form a molten pool in the printing object. The base material supply source is configured to supply the base material to the printing object. The thermal imaging camera is configured to create a thermal image of the molten pool. The laser ultrasonic device is configured to receive a laser ultrasound wave included in a laser beam reflected, after being incident on the printing object, from the 3D printing laser source. The control unit configured to estimate a physical property of the printing object and detect a defect of the printing object based on a thermal image created by the thermal imaging camera and the laser ultrasound wave received by the laser ultrasonic device.

In an embodiment, the thermal imaging camera and the laser ultrasonic device may be disposed coaxially with the 3D printing laser source.

In an embodiment, the base material may be metal powder or metal wire.

In an embodiment, the control unit may detect presence of a defect in the printing object according to an additional reflected wave of the laser ultrasound wave and a change in a thermal energy distribution of the thermal image.

In an embodiment, the control unit may estimate a stiffness of the printing object according to an arrival time and a wave speed of the laser ultrasound wave and a thermal energy transfer speed of the thermal image.

In an embodiment, the 3D printing system may further include a first beam splitter disposed on a path of the laser beam irradiated from the 3D printing laser source and configured to separate a part of the laser beam reflected from the printing object unit toward the thermal imaging camera; and a second beam splitter disposed on a path of the laser beam irradiated from the 3D printing laser source and configured to separate a part of the laser beam reflected from the printing object toward the laser ultrasonic device.

In an embodiment, the 3D printing system may further include a first filter unit disposed between the first beam splitter and the thermal imaging camera and configured to allow a light beam of an operational wavelength band of the thermal imaging camera to pass; and a second filter unit disposed between the second beam splitter and the laser ultrasonic device and configured to allow a signal of an operational wavelength band of the laser ultrasonic device to pass.

In an embodiment, the thermal imaging camera and the laser ultrasonic device may have an operational wavelength band different from that of the 3D printing laser source.

The integrated inspection system of the 3D printing process and the 3D printing system equipped with the same according to the embodiments of the present invention can perform estimation of the physical properties and detection of the defects of the printing object in real time during the 3D printing process and in a non-destructive manner by using the thermal image and the laser ultrasonic response of the printing object in combination.

According to the present invention, better inspection results can be provided by using combined data of the thermal image and the laser ultrasonic response for inspection. Therefore, if a quality defect is detected during the 3D printing process, the printing process can be stopped and the corresponding printing object can be disposed of early. Accordingly, the efficiency of the 3D printing process can be improved and production costs can be reduced. In addition, it is possible to improve the control precision and quality of the 3D printing process through real-time feedback control.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram of a 3D printing system according to an embodiment of the present disclosure.

FIG. 2 is a diagram schematically illustrating the generation of a molten pool, a thermal wave, and a laser ultrasound wave in a 3D printing object by a laser source in the 3D printing system according to an embodiment of the present disclosure.

FIG. 3 is a diagram illustrating an example of data fusion-based defect detection from a laser ultrasound wave and a thermal image using a pulse-echo technique in the 3D printing system according to an embodiment of the present disclosure.

FIG. 4 is a diagram illustrating an example of data fusion-based physical property estimation from a laser ultrasound wave and a thermal image using a pitch-catch technique in the 3D printing system according to an embodiment of the present disclosure.

FIG. 5 is a view showing an example of enhanced defect detection and physical property estimation based on data fusion of a laser ultrasound wave and a thermal image in the 3D printing system according to an embodiment of the present invention.

### DETAILED DESCRIPTION OF THE EMBODIMENTS

Hereinafter, embodiments of the present disclosure will be described in detail with reference to the accompanying drawings. The present disclosure may be implemented in various different forms, and is not limited to the embodiments described herein. In the drawings, parts irrelevant to the description are omitted in order to clearly describe the present disclosure, and the same reference numerals are assigned to the same or similar elements throughout the specification.

The 3D printing system according to an embodiment of the present disclosure is a system capable of melting a base material using a laser to form a three-dimensional object, and also capable of real-time feedback process control by performing on-line nondestructive evaluation (NDE) during the 3D printing process. In this case, the 3D printing system according to an embodiment of the present disclosure may be a DED type 3D printing system capable of forming a 3D object by melting metal powder or metal wire with a laser.

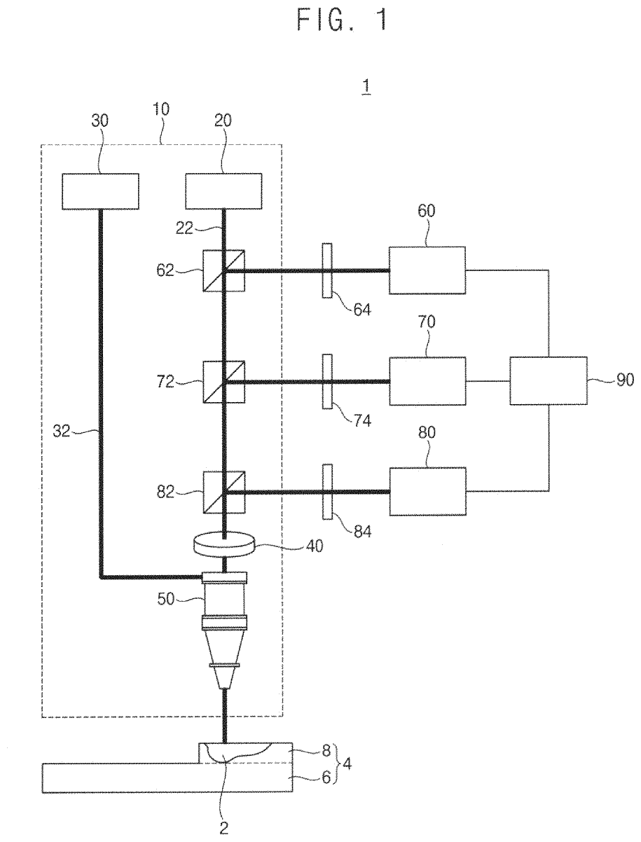

FIG. 1 illustrates a configuration of a 3D printing system according to an embodiment of the present disclosure.

Referring to FIG. 1, in an example embodiment the 3D printing system 1 may include a laser source 20 for 3D printing, a base material supply source 30, a focus lens 40, a nozzle 50, a thermal imaging camera 60 such as an infra-red camera, a vision camera 70, a laser ultrasonic device 80, and a control unit 90.

Here, the laser source 20, the base material supply source 30, the focus lens 40, and the nozzle 50 may constitute a general DED type 3D printer 10. However, the 3D printer 10 applicable to the 3D printing system 1 according to an embodiment of the present disclosure is not limited to the DED method. A 3D printer capable of forming a molten pool of metal may applicable to the 3D printing system 1 according to the present disclosure.

In an example embodiment, the 3D printing system 1 may include the thermal imaging camera 60, the vision camera 70, and the laser ultrasonic device 80 which are coaxially provided with the DED type 3D printer 10. In other words, the thermal imaging camera 60, the vision camera 70, and the laser ultrasonic device 80 may be disposed coaxially with the laser source 20. Here, the coaxial disposition means that related components are arranged so that a plurality of laser beams share the same optical path, and a beam splitter, a dichroic mirror, a filter unit, etc. make the laser beams be separated and/or transmit so that the laser beams share the optical path.

Accordingly, it is possible to continuously photograph and inspect the 3D printing object 4 without controlling positions of the thermal imaging camera 60, the vision camera 70, and the laser ultrasonic device 80.

In an example embodiment, the thermal imaging camera 60, the vision camera 70, the laser ultrasonic device 80, and the control unit 90 may form a thermal image and laser ultrasound integrated inspection system 100 for 3D printing process. Accordingly, the 3D printing system 1 includes the 3D printer 10 and the thermal image and laser ultrasound integrated inspection system 100 for the 3D printing process.

Referring to FIG. 1, in an example embodiment, the laser source 20 may irradiate a laser beam 22 to a 3D printing object 4. The laser beam 22 generated from the laser source 20 passes through the focus lens 40 and is incident on the 3D printing object 4. The laser beam 22 irradiated from the laser source 20 may pass through the nozzle 50 for supplying the base material while the laser beam 22 reaches a molten pool 2. Here, the laser source 20 may have an operational wavelength band of, for example, 1.07 μm or less.

In an example embodiment, the base material supplied from the base material supply source 30 may be fed to the nozzle 50 in the form of, for example, metal powder or metal wire through a separate supply pipe 32. To supply the base material to the 3D printing object 4, the movement path of the base material in the nozzle 50 may be formed to be parallel to or oblique to the path through which the laser beam 22 passes. The base material supplied to the 3D printing object 4 may be melted by the laser beam 22 to form the molten pool 2 in the 3D printing object 4.

The 3D printing object 4 may be formed as a three-dimensional object by laminating a plurality of layers. In FIG. 1, illustrated is an example state where the 3D printing object 4 is formed of, for example, a first layer 6 and a second layer 8, and the molten pool 2 is formed on the second layer 8.

The thermal imaging camera 60 may acquire a thermal image of the molten pool 2 formed in the 3D printing object 4. Here, the thermal imaging camera 60 may have an operational wavelength band different from that of the laser source 20. As an example, the thermal imaging camera 60 may be operative to a wavelength band of 2-5μm.

In order to configure the thermal imaging camera 60 in a coaxial arrangement with the laser source 20, a first beam splitter 62 may be disposed on the path of the laser beam 22 irradiated from the laser source 20. The laser beam 22 generated from the laser source 20 passes through the first beam splitter 62 and the focus lens 40, entering the printing object 4, then being reflected from the 3D printing object 4. The first beam splitter 62 may separate a part of the laser beam 22 reflected from the 3D printing object 4 toward the thermal imaging camera 60.

In addition, a first filter unit 64 may be disposed between the first beam splitter 62 and the thermal imaging camera 60. In this case, the first filter unit 64 may allow the light of wavelength band that can be photographed by the thermal imaging camera 60 to pass through itself. Accordingly, the thermal imaging camera 60 can obtain a thermal image by extracting only an infrared signal of the wavelength band that can be photographed by itself from the laser beam 22 that transferred through the first beam splitter 62 after being reflected by the printing object 4.

The vision camera 70 may photograph a real image of the 3D printing object 4. Here, the vision camera 70 may photograph the light of an operational wavelength band different from the that of the laser source 20. As an example, the vision camera 70 may capture the light of an operational wavelength band of 600 nm to 900 nm as a vision image.

In an example embodiment, in order to configure the vision camera 70 in a coaxial arrangement with the laser source 20, a third beam splitter 82 may be disposed on the path of the laser beam 22 generated from the laser source 20. The third beam splitter 72 may separate a part of the laser beam 22 that is incident on and then reflected from the 3D printing object 4 toward the vision camera 70.

In an example embodiment, a third filter unit 74 may be disposed between the third beam splitter 72 and the vision camera 70. In this case, the third filter unit 74 may allow the light of a wavelength band that the vision camera 70 can photograph to pass through itself. Accordingly, the vision camera 70 may extract only the light of its own operational wavelength band from the laser beam 22 to obtain an image of the 3D printing object 4 in a state of processing.

The laser ultrasonic device 80 may receive laser ultrasound waves reflected from the 3D printing object 4. Here, the laser ultrasonic device 80 may have an operational wavelength band different from that of the laser source 20. As an example, the laser ultrasonic device 80 may be operative to a wavelength band of 515 nm or less. In addition, the laser ultrasonic device 80 may be a femtosecond laser device.

In an example embodiment, a second beam splitter 82 may be disposed on the path of the laser beam 22 irradiated from the laser source 20 to configure the laser ultrasonic device 80 in a coaxial arrangement with the laser source 20. The second beam splitter 82 may separate a part of the laser beam 22 that is incident on and then reflected from the 3D printing object 4 toward the laser ultrasonic device 80.

In an example embodiment, a second filter unit 84 may be disposed between the second beam splitter 82 and the laser ultrasonic device 80. In this case, the second filter unit 84 may allow a signal of the operational wavelength band of the ultrasonic laser device 80 to pass through itself. Thereby, the laser ultrasonic device 80 can selectively receive only laser ultrasound of its own operational wavelength band from the laser beam 22.

Here, for the coaxial arrangement of the thermal imaging camera 60, the vision camera 70, and the laser ultrasonic device 80, it is illustrated and described as having only the beam splitters 62, 72, and 82 and filter units 64, 74, and 84, but it may include an optical path converter such as a mirror having a constant reflection angle, or a dichroic mirror that passes or reflects a specific wavelength band.

In FIG. 1, the thermal imaging camera 60, the vision camera 70, and the laser ultrasonic device 80 are illustrated to be disposed on one side of the laser beam 22, but are not limited thereto. For example, the thermal imaging camera 60, the vision camera 70, and the laser ultrasonic device 80 may be disposed on both sides of the laser beam 22 according to the deformation of the beam splitters 62, 72, and 82.

The control unit 90 may estimate the physical properties of the printing object 4 and detect defects of the printing object 4 based on the thermal image acquired by the thermal imaging camera 60 and the response of the laser ultrasound wave received by the laser ultrasonic device 80.

In an example embodiment, as will be described later, the control unit 90 may calculate a laser ultrasonic response using a pulse-echo technique or a pitch-catch technique.

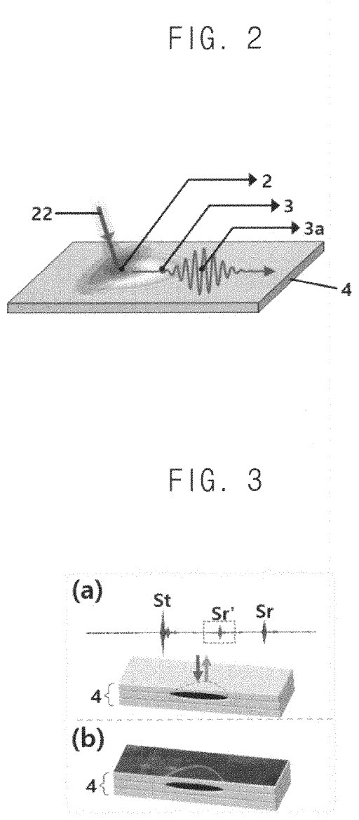

Hereinafter, the physical property estimation and the defect detection based on data fusion of the thermal image and laser ultrasound wave will be described with reference to FIGS. 2 to 5.

FIG. 2 schematically illustrates a molten pool, a thermal wave, and a laser ultrasound wave generated in a 3D printing object by a laser source of the 3D printing system according to an embodiment of the present disclosure.

Referring to FIG. 2, the laser beam 22 irradiated from the laser source 20 may be irradiated onto the 3D printing object 4 to form a molten pool 2.

In an example embodiment, the thermal wave 3 may be generated by the thermal energy of the laser beam 22 or the heat of the melting pool 2. The generated thermal wave 3 may propagate along the 3D printing object 4. Here, the thermal wave 3 may be related to the thermal energy distribution, the thermal energy transmission rate, or the heat diffusion rate of the 3D printing object 4. That is, the thermal energy distribution, the thermal energy transmission rate, or the heat diffusion rate may be affected by the physical property and defects of the 3D printing object 4.

In addition, as the laser beam 22 is reflected from the 3D printing object 4, a laser ultrasound wave 3a may be generated. That is, the laser beam 22 traveling in the thickness direction of the 3D printing object 4 may be reflected from its surface (upper or lower) and emitted back to the outside of the 3D printing object 4. The reflected wave may be a laser ultrasound wave 3a.

The laser ultrasound wave 3a may be related to the arrival time or wave velocity as a response to the 3D printing object 4. That is, the arrival time and wave velocity of the laser ultrasound wave 3a may be affected by the physical property and defects of the 3D printing object 4. Here, the arrival time refers to a time taken from the time of irradiation of the laser beam 22 to the time of reception of the laser ultrasound wave 3a by reflection.

As described above, the thermal image and the response of the laser ultrasound wave 3a may interact according to the printing state of the 3D printing object 4 to exhibit the 3D printing quality. In other words, the thermal image and the response of the laser ultrasound wave 3a may be varied according to the physical property and defects of the 3D printing object 4.

FIG. 3 illustrates an example of defect detection based on a laser ultrasound wave and a thermal image by a pulse-echo method in the 3D printing system according to an embodiment of the present disclosure.

When there is no defect in the 3D printing object 4, the laser beam 22 irradiated to the 3D printing object 4 may generate a reflected wave St reflected by the top surface of the 3D printing object 4 and a reflected wave Sr reflected by the bottom surface of the 3D printing object 4. Here, the response of the laser ultrasound wave 3a may be obtained using the pulse-echo method, and an irradiation position of the laser beam 22 and a reception position of the laser ultrasound wave 3a may be the same.

However, when a defect such as a void exists in the 3D printing object 4, the laser beam 22 irradiated to the 3D printing object 4 may generate an additional reflected wave Sr′ caused by the void as shown in (a) of FIG. 3. That is, it may be determined whether or not the 3D printing object 4 is defective according to whether the additional reflected wave Sr′ is generated or not. In other words, when the additional reflected wave Sr′ is detected in addition to the normal reflected waves St and Sr, it may be estimated that a void exists in the 3D printing object 4.

On the other hand, the thickness of the 3D printing object 4 may be determined based on the reflected waves St and Sr. In this case, it may not be clear whether the additional reflected wave Sr′ is due to a defect or a thickness change of the 3D printing object 4. To compensate for this, it is possible to determine whether there is a defect by combining the data of the thermal image thereto.

In more detail, as shown in (b) of FIG. 3, when the defect such as the void exist in the 3D printing object 4, the history of thermal energy of the 3D printing object 4 may be changed. That is, the distribution of thermal energy of the 3D printing object 4 may be changed. In this way, it is possible to determine whether the 3D printing object 4 is defective according to whether the thermal energy distribution of the 3D printing object 4 changes or not based on the thermal image. In other words, if the thermal energy distribution in the thermal image of the 3D printing object 4 changes, it can be estimated that a defect in the 3D printing object 4 exists.

In an example embodiment, the control unit 90 may detect the presence of any defect in the 3D printing object 4 based on the additional reflected wave Sr′ of the response of the laser ultrasound wave and change in the thermal energy distribution of the thermal image. As a result, compared to the case of monitoring only the response of the laser ultrasound or the change in the thermal energy distribution of the thermal image, the present disclosure can more accurately detect whether or not the 3D printing object 4 is defective.

As described above, according to the present invention, since defect detection can be performed in real time during the 3D printing process, the printing process may be stopped immediately upon detection of the defect and the printing object with the defect may be discarded without cost loss, thereby improving the efficiency of the 3D printing process. In addition, since the printing process can be feedback controlled in real-time, the present invention can improve quality of the 3D printing products.

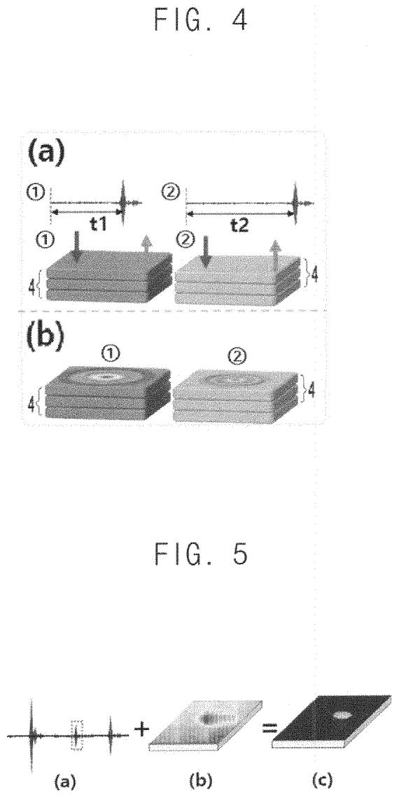

FIG. 4 illustrates an example of estimating physical properties based on data fusion of the laser ultrasound wave and the thermal image using a pitch-catch method in the 3D printing system according to an embodiment of the present disclosure.

As shown in (a) of FIG. 4, the arrival time of the laser ultrasound wave 3a may vary according to physical properties such as rigidity, elastic modulus, etc. of the 3D printing object 4. Here, the response of the laser ultrasound wave 3a may be obtained using the pitch-catch method, and the irradiation position of the laser beam 22 and the receiving position of the laser ultrasound wave 3a are different.

With reference to (a) of FIG. 4, when the 3D printing object 4 is stiff, the arrival time (t1) of the laser ultrasound wave 3a is relatively short as shown in \textcircled{1}. Further, when the 3D printing object 4 is soft, the arrival time (t2) of the laser ultrasound wave 3a is relatively long. That is, according to the arrival time of the laser ultrasound wave 3a, it is possible to estimate the physical property such as rigidity of the 3D printing object 4.

Meanwhile, since the arrival time of the laser ultrasound wave 3a is measured by a reflected wave by the 3D printing object 4, it may depend on a change in the thickness of the 3D printing object 4. That is, the physical properties of the 3D printing object 4 may not be clearly estimated only by the arrival time of the laser ultrasound wave 3a. To compensate for this, it is possible to determine whether there is a defect by using the data of the thermal image in combination with the data of arrival time.

As shown in (b) of FIG. 4, heat propagation characteristics may vary according to the physical property of the 3D printing object 4. That is, the thermal energy transmission rate of the 3D printing object 4 may vary. Here, the thermal energy transmission rate may depend on the heat diffusion rate of the 3D printing object 4. In this way, it is possible to estimate physical property such as rigidity of the 3D printing object 4 according to the thermal energy transmission rate of the 3D printing object 4.

In this case, the control unit 90 may estimate the rigidity of the 3D printing object 4 according to the arrival time and wave velocity of the response of the laser ultrasound wave 3a and the thermal energy transmission rate in the thermal image. Using several data for the estimation like this can provide more accurate estimation of the physical properties of the 3D printing object 4, compared to the case of monitoring only either the response of the laser ultrasound wave or the change in the thermal energy transmission rate in the thermal image.

FIG. 5 illustrates an example of enhanced defect detection and physical property estimation based on data fusion of the laser ultrasound wave and the thermal image in the 3D printing system.

Referring to FIG. 5, the response data of the laser ultrasound wave 3a as shown in (a) and data on the thermal energy history or heat propagation characteristics according to the thermal image as shown in (b) may be fused. By such data fusion, an enhanced defect detection image as shown in (c) can be generated. By using the obtained defect detection image, it is possible to more accurately perform defect detection and physical property estimation of the printing object 4.

With such a configuration, the inspection system and the 3D printing system according to the present invention can perform product property estimation and defect detection in real time and in the non-destructive manner during the 3D printing process. Accordingly, it is possible to improve the control precision and quality of the 3D printing process.

The present invention can provide better inspection results. Thus, early disposal of defective products during the 3D printing process is possible. In addition, real-time feedback control to improve product quality is possible. Accordingly, the efficiency of the 3D printing process can be improved.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims.

What is claimed is:

1. An integrated inspection system for a 3D printing process based on a thermal image and a laser ultrasound wave, comprising:
a thermal imaging camera configured to create a thermal image of a molten pool formed in a printing object when a base material supplied to the printing object is melted by a laser beam irradiated from a 3D printing laser source;
a laser ultrasonic device configured to receive a laser ultrasonic wave included in a laser beam reflected from the printing object after being radiated onto the printing object; and
a control unit configured to estimate a physical property of the printing object and detect a defect of the printing object based on the thermal image created by the thermal imaging camera and the laser ultrasound wave received by the laser ultrasonic device,
wherein the thermal imaging camera and the laser ultrasonic device are disposed coaxially with the 3D printing laser source.

2. The integrated inspection system of claim 1, wherein the control unit detects presence of a defect in the printing object according to an additional reflected wave of the laser ultrasound wave and a change in a thermal energy distribution of the thermal image.

3. The integrated inspection system of claim 1, wherein the control unit estimates a stiffness of the printing object according to an arrival time and a wave speed of the laser ultrasound wave and a thermal energy transfer speed of the thermal image.

4. The integrated inspection system of claim 1, wherein the control unit calculates a response of the laser ultrasound wave using a pulse-echo technique or a pitch-catch technique.

5. The integrated inspection system of claim 1, further comprising a first beam splitter disposed on a path of the laser beam irradiated from the 3D printing laser source and configured to separate a part of the laser beam reflected from the printing object unit toward the thermal imaging camera; and a second beam splitter disposed on a path of the laser beam irradiated from the 3D printing laser source and configured to separate a part of the laser beam reflected from the printing object toward the laser ultrasonic device.

6. The integrated inspection system of claim 5, further comprising a first filter unit disposed between the first beam splitter and the thermal imaging camera and configured to allow a light beam of an operational wavelength band of the thermal imaging camera to pass; and a second filter unit disposed between the second beam splitter and the laser ultrasonic device and configured to allow a signal of an operational wavelength band of the laser ultrasonic device to pass.

7. The integrated inspection system of claim 1, wherein the thermal imaging camera and the laser ultrasonic device has an operational wavelength band different from that of the 3D printing laser source.

8. The integrated inspection system of claim 7, wherein the thermal imaging camera has an operational wavelength band of 2˜5 μm.

9. The integrated inspection system of claim 7, wherein the laser ultrasonic device has an operational wavelength band of 515 nm or less.

10. The integrated inspection system of claim 7, wherein the 3D printing laser source has an operational wavelength band of 1.07 μm or less.

11. The integrated inspection system of claim 7, wherein the laser ultrasonic device is a femtosecond laser device.

12. The integrated inspection system of claim 1, further comprising a vision camera configured to create an image of the printing object; a third beam splitter disposed on a path of the laser beam irradiated from the 3D printing laser source and configured to separate a part of the laser beam reflected from the printing object toward the vision camera; and a third filter unit disposed between the third beam splitter and the vision camera and configured to allow a light beam of an operational wavelength band of the vision camera to pass.

13. A 3D printing system, comprising:
a 3D printing laser source configured to irradiate a laser beam to melt a base material supplied to a printing object and to form a molten pool in the printing object;
a base material supply source configured to supply the base material to the printing object;
a thermal imaging camera configured to create a thermal image of the molten pool;
a laser ultrasonic device configured to receive a laser ultrasound wave included in a laser beam reflected, after being incident on the printing object, from the 3D printing laser source; and
a control unit configured to estimate a physical property of the printing object and detect a defect of the printing object based on a thermal image created by the thermal imaging camera and the laser ultrasound wave received by the laser ultrasonic device.

14. The 3D printing system of claim 13, wherein the thermal imaging camera and the laser ultrasonic device are disposed coaxially with the 3D printing laser source.

15. The 3D printing system of claim 13, wherein the base material is metal powder or metal wire.

16. The 3D printing system of claim 13, wherein the control unit detects presence of a defect in the printing object according to an additional reflected wave of the laser ultrasound wave and a change in a thermal energy distribution of the thermal image.

17. The 3D printing system of claim 13, wherein the control unit estimates a stiffness of the printing object according to an arrival time and a wave speed of the laser ultrasound wave and a thermal energy transfer speed of the thermal image.

18. The 3D printing system of claim 13, further comprising a first beam splitter disposed on a path of the laser beam irradiated from the 3D printing laser source and configured to separate a part of the laser beam reflected from the printing object unit toward the thermal imaging camera; and a second beam splitter disposed on a path of the laser beam irradiated from the 3D printing laser source and configured to separate a part of the laser beam reflected from the printing object toward the laser ultrasonic device.

19. The 3D printing system of claim 18, further comprising a first filter unit disposed between the first beam splitter and the thermal imaging camera and configured to allow a light beam of an operational wavelength band of the thermal imaging camera to pass; and a second filter unit disposed between the second beam splitter and the laser ultrasonic device and configured to allow a signal of an operational wavelength band of the laser ultrasonic device to pass.

20. The 3D printing system of claim 13, wherein the thermal imaging camera and the laser ultrasonic device has an operational wavelength band different from that of the 3D printing laser source.
